(19) United States
(12) Patent Application Publication
(10) Pub. No.: US 2014/0376728 A1
(43) Pub. Date: Dec. 25, 2014

(54) AUDIO SOURCE PROCESSING

(71) Applicants: Anssi Sakari Rämö, Tampere (FI); Mikko Tapio Tammi, Tampere (FI); Erika Piia Pauliina Reponen, Tampere (FI); Sampo Vesa, Helsinki (FI)

(72) Inventors: Anssi Sakari Rämö, Tampere (FI); Mikko Tapio Tammi, Tampere (FI); Erika Piia Pauliina Reponen, Tampere (FI); Sampo Vesa, Helsinki (FI)

(73) Assignee: Nokia Corporation, Espoo (FI)

(21) Appl. No.: 14/374,660

(22) PCT Filed: Mar. 12, 2012
(86) PCT No.: PCT/FI2012/050234

§ 371 Date: Jul. 25, 2014

(51) Int. Cl. H04R 29/00

(52) U.S. Cl. CPC H04R 29/00
USPC 381/56

(57) ABSTRACT

It is inter alia disclosed to check whether an audio signal captured from an environment of the apparatus comprises arriving sound from an audio source of interest, and to provide a direction identifier being indicative on the direction of the arriving sound from the audio source of interest via a user interface when said check yields a positive result.

### FIELD

Embodiments of this invention relate to audio source direction notification and applications thereof.

### BACKGROUND

Although human audio perception system is quite efficient locating different audio sources there are several signals that can be extremely hard to locate. It is a known fact that for example very high frequency or very low frequency is almost impossible to locate for a human being.

For instance, some of these hard to find audio source may be the following:
Subwoofer
Beeping (out of battery) fire alarm
Mobile phone ringing tone
Insects
Broken whirring, beeping, etc. devices
The exact location in the (large) device

In addition, it might be useful to notify a user about audio occurrences when the user is otherwise unable to listen. E.g., when listening to music from a handheld device with noise suppressing headset when walking through the environment, it may be useful if the user notices audio sources behind the user, which require user attention.

### SUMMARY OF SOME EMBODIMENTS OF THE INVENTION

Thus, notifying a user about audio occurrences may be desirable.

According to a first aspect of the invention, a method is disclosed, said method comprising checking whether an audio signal captured from an environment of the apparatus comprises arriving sound from an audio source of interest, and providing a direction identifier being indicative on the direction of the arriving sound from the audio source of interest via a user interface when said check yields a positive result.

According to a second aspect of the invention, an apparatus is disclosed, which is configured to perform the method according to the first aspect of the invention, or which comprises means for performing the method according to the first aspect of the invention, i.e. means for checking whether an audio signal captured from an environment of the apparatus comprises arriving sound from an audio source of interest, and means for providing a direction identifier being indicative on the direction of the arriving sound from the audio source of interest via a user interface when said check yields a positive result.

According to a third aspect of the invention, an apparatus is disclosed, comprising at least one processor and at least one memory including computer program code, the at least one memory and the computer program code configured to, with the at least one processor, cause the apparatus at least to perform the method according to the first aspect of the invention. The computer program code included in the memory may for instance at least partially represent software and/or firmware for the processor. Non-limiting examples of the memory are a Random-Access Memory (RAM) or a Read-Only Memory (ROM) that is accessible by the processor.

According to a fourth aspect of the invention, a computer program is disclosed, comprising program code for performing the method according to the first aspect of the invention when the computer program is executed on a processor. The computer program may for instance be distributable via a network, such as for instance the Internet. The computer program may for instance be storable or encodable in a computer-readable medium. The computer program may for instance at least partially represent software and/or firmware of the processor.

According to a fifth aspect of the invention, a computer-readable medium is disclosed, having a computer program according to the fourth aspect of the invention stored thereon. The computer-readable medium may for instance be embodied as an electric, magnetic, electro-magnetic, optic or other storage medium, and may either be a removable medium or a medium that is fixedly installed in an apparatus or device. Non-limiting examples of such a computer-readable medium are a RAM or ROM. The computer-readable medium may for instance be a tangible medium, for instance a tangible storage medium. A computer-readable medium is understood to be readable by a computer, such as for instance a processor.

According to a sixth aspect of the invention, a computer program product comprising a least one computer readable non-transitory memory medium having program code stored thereon is disclosed, the program code which when executed by an apparatus cause the apparatus at least to check whether an audio signal captured from an environment of the apparatus comprises arriving sound from an audio source of interest, and to provide a direction identifier being indicative on the direction of the arriving sound from the audio source of interest via a user interface when said check yields a positive result.

According to a seventh aspect of the invention, a computer program product is disclosed, the computer program product comprising one ore more sequences of one or more instructions which, when executed by one or more processors, cause an apparatus at least to check whether an audio signal captured from an environment of the apparatus comprises arriving sound from an audio source of interest, and to provide a direction identifier being indicative on the direction of the arriving sound from the audio source of interest via a user interface when said check yields a positive result.

In the following, features and embodiments pertaining to all of these above-described aspects of the invention will be briefly summarized.

It is checked whether an audio signal captured from an environment of an apparatus comprises arriving sound from an audio source of interest, and if this checking yields a positive result, it may be proceeded with providing a direction identifier being indicative on the direction of the arriving sound from the audio source of interest via a user interface. For instance, this audio signal may represent an actually captured audio signal or a previously captured audio signal.

For instance, the apparatus may represent a mobile apparatus. As an example, the apparatus may represent a handheld device, e.g. a smartphone or tablet computer or the like.

For instance, the apparatus may be configured to determine the direction of an audio source with respect to the orientation of the apparatus, wherein the audio source may represent the dominant audio source in the environment. For instance, the apparatus may comprise or be connected to the spatial sound detector in order to determine the direction of a dominant audio source with respect to the orientation of the apparatus.

As an example, the determined direction represents the direction of the detected audio source with respect to the apparatus, wherein the direction may represent a two-dimensional direction or may represent a three-dimensional direction.

Based on the captured audio signal it is checked whether the audio signal comprise arriving sound from an audio source of interest.

For instance, the apparatus may comprise at least one predefined rule in order to determine whether a captured sound comprises arriving sound from an audio source of interest. As an example, a first rule may define that an arrived sound exceeding a predefined signal level represents a sound from an audio source of interest and/or a second rule may define that an arrived sound comprising a sound profile which substantially matches with a sound profile of database comprising a plurality of stored sound profiles of audio sources of interest represents a sound from an audio source of interest.

Thus, sound arrived from audio sources of interest may be distinguished from other audio source, i.e., audio sources not of interest, and thus, a direction identifier being indicative on the direction of the arriving sound may be only presented via the user interface if the captured sound comprises arriving sound from an audio source of interest.

For instance, sound captured from an audio source which is located far away from the apparatus may not represent a sound from an audio source of interest, since the audio source is far a way from the apparatus and, for instance, may thus cause no interest and/or no danger for a user of the apparatus. As an example, in this example scenario only a weak sound signal may be received, and when the exemplary first rule may be used for determining whether the captured sound comprises arriving sound from an audio source of interest, the level of the captured sound may not exceed the predefined signal level and thus no audio source if interest may be detected.

Accordingly, no direction identifier being indicative on the direction of the arriving sound is presented if the audio source was not determined to represent an audio source of interest. Thus, no unnecessary information is presented to the user via the user interface, and, due to the less information provided via the user interface, power consumption of the apparatus may be reduced.

The direction identifier being indicative on the direction of the arriving sound from the audio source of interest provided via the user interface may represent any information which indicates the direction of the arriving sound from the audio source of interest with respect to the orientation of the apparatus.

For instance, the user interface may comprise a visual interface, e.g. a display, and/or an audio interface, and the direction identifier may be provided via the visual interface and/or the audio interface to a user. Accordingly, the direction identifier may comprise a visual direction identifier and/or an audio direction identifier.

Thus, a user can be informed about the direction of the sound of interest by means of the direction identifier provided via the user interface.

For instance, if a user walks around an outdoor environment, thereby listening music with noise suppressing headset from the apparatus, and, as an example, a dog barks loudly behind the user, the user would usually not be able to identify this dog due to wearing the noise suppressing headset, but the apparatus would be able to determine that a captured sound from dog barking behind the user represents an arrived sound from an audio source of interest, and thus a corresponding direction identifier could be provided to the user via the user interface being indicative of the direction of the arriving sound from the audio source of interest, i.e., the barking dog.

Accordingly, although the noise suppressing headset acoustically encapsulates the user from the environment, the user is informed about audio sources of interest, even if the audio source of interest is not in the field of view of the user. Thus, for instance, the user may be informed about dangerous objects if these dangerous objects can be identified as audio source of interest by means of presenting the direction identifier being indicative of the via the user interface.

Furthermore, for instance, after the direction indicator has been provided, the method may jump to the beginning and may proceed with determining whether an audio signal captured from an environment of the apparatus comprises arriving sound from an audio source of interest.

For instance, if the user interface comprises an audio interface, e.g. an audio interface being configured to provide sound to a user via at least one loudspeaker. Then, as an example, the direction identifier provided by the audio interface may for instance represent a spoken information being descriptive of the direction of the audio source. For instance, said information being descriptive of the direction may comprise information whether the sound arrives from the front or rear of the user, e.g. the spoken wording “front” or “rear” or the like, and may comprise further information on the direction, e.g. “left”, “mid” or “right” or the like. For instance, this spoken information being descriptive of the direction may be stored as digitized samples for different directions and one of the spoken information may be selected and played back in accordance with the determined direction of the arriving sound from the audio source of interest.

Furthermore, as an example, said optional audio interface may be configured to provide a spatial audio signal to a user. For instance, said optional audio interface may represent a headset comprising two loudspeakers, which can be controlled by the apparatus in order play back spatial audio. Then, as an example, the direction identifier may comprise an audio signal provided in a spatial direction corresponding to the arriving sound from the audio source of interest via the audio interface.

According to an exemplary embodiment of all aspects of the invention, said providing the direction identifier comprises overlaying the direction identifier at least partially on a stream outputted by the user interface.

For instance, if the user interface comprises an audio interface, the audio interface may be configured to play back an audio stream to the user. The direction identifier may comprise an acoustical identifier which is at least partially overlaid on the outputted audio stream. Partial overlaying may be understood in a way that play back of original audio stream via the audio interface is not stopped, but that the acoustical identifier is overlaid in the audio signal of the audio stream. For instance, the loudness of the audio stream may be reduced when the acoustical identifier is overlaid on the audio stream. Complete overlaying may be understood that the loudness of the audio stream is reduced to zero (for instance, the audio stream may be stopped) during the acoustical identifier is overlaid.

Furthermore, for instance, if the user interface comprises a visual interface, the stream may represent a video stream presented on the visual interface. As an example, the video stream may represent a video of the actually captured environment which may be captured by means of camera of the apparatus. Furthermore, the video stream may represent a still picture. The direction identifier may comprise a visual identifier which is at least partially overlaid on the outputted video stream. Partial overlaying may be understood in a way that presenting of original video stream via the visual interface is not completely, but that the visual identifier is overlaid on the video stream in the visual interface in a way that at least some parts of the video stream can still be seen on the visual interface. Complete overlaying may be understood that of the video stream is not shown on the visual display during the visual identifier is completely overlaid on the video stream, e.g. this may be achieved by placing the visual identifier on top of the video stream.

According to an exemplary embodiment of all aspects of the invention, said user interface comprises a display and said stream represents a video stream, and wherein said overlaying an indicator of the direction comprises one out of: visually augmenting the video stream shown on the display with the direction identifier, and stopping presentation of the video stream on the display and providing the direction identifier on top of the display.

For instance, a video stream shown on the display may be visually augmented with the direction identifier. As an example, this may comprise visually augmenting the video stream with the direction identifier in the video stream at a position indicating the direction of the arriving sound from the audio source of interest. Thus, the position of the direction identifier may indicate the direction of the arriving sound from the audio source of interest in this example.

Or, as an example, visually augmenting the video stream with the direction identifier in the video stream may comprise using a direction identifier which comprises information being descriptive of the direction of the arriving sound from the audio source of interest.

For instance, stopping presentation of the video stream on the display and providing the direction identifier on top of the display may be used of the audio source is identified as an audio source of danger so that the attention can be drawn to direction identifier in a better way. As an example, the direction identifier may be placed at a position on the display indicating the direction of the arriving sound from the audio source of interest, or the direction identifier may comprise information being descriptive of the direction of the arriving sound from the audio source of interest.

As an example, the binary identifier may represent a binary large object (BLOB), which may represent a collection of binary data stored a single entity. For instance, a plurality of BLOBs may be stored in a database and the method may select an appropriate BLOB for identifying the direction. As an example, a BLOBB may represent an image, an audio or another multimedia object.

According to an exemplary embodiment of all aspects of the invention, the video stream represents a video stream captured from the environment, the method comprising checking whether the direction of the arriving sound from the audio source of interest is in the field of view of the captured video stream, and, if this checking yields a positive result, visually augmenting the video stream with the direction identifier in the video stream at a position indicating the direction of the arriving sound from the audio source of interest, and, if this checking yields a negative result, visually augmenting the video stream with the direction identifier in the video stream, wherein the direction identifier comprises information being descriptive of the direction of the arriving sound from the audio source of interest.

For instance, if the checking whether the direction of the arriving sound from the audio source of interest is in the field of view of the captured video stream yields a positive result, the method may proceed with visually augmenting the video stream with the direction identifier in the video stream at a position indicating the direction of the arriving sound from the audio source of interest. As an example, a marker being positioned at a position indicating the direction of the arriving sound from the audio source of interest may be used as direction identifier. Due to this position, the user is informed about the direction of the arriving sound.

Furthermore, as an example, if the direction of the arriving sound from the audio source of interest is not in the field of view of the captured video stream, e.g. since the audio source of interest may be behind a user of the apparatus and is not in the field of view of the captured video stream, the checking may yield in negative result, and the method proceeds with visually augmenting the video stream with the direction identifier in the video stream, wherein the direction identifier comprises information being descriptive of the direction of the arriving sound from the audio source of interest. The, as an example, a pointing object pointing to the direction of the arriving sound from the audio source of interest may be used a direction identifier. As an example, this pointing object may be shown in a border of the display (under the assumption that the display comprises borders) basically corresponding to the direction of the arriving sound and may further be oriented in order to describe the direction of the arriving sound from the audio source of interest. It has to be understood that other graphical representations may be used a directional identifier being descriptive of the arriving sound from the audio source of interest than the pointing object.

According to an exemplary embodiment of all aspects of the invention, said direction identifier comprises at least one of the following: a marker, a binary large object; an icon; a pointing object pointing to the direction of the arriving sound.

The marker may represent a direction identifier which is configured to show the direction by placing the marker on the respective position on the display being corresponding to the direction of the arriving sound, thereby marking the direction of the arriving sound. As an example, the marker may comprise no further additional information on the direction and/or on the type of audio source.

For instance, a plurality of binary large objects (BLOB) may be provided, wherein each BLOB of at least one BLOB of the plurality of is associated with a respective type of audio source and is indicative of the respective type of audio source.

For instance, a plurality of icons may be provided, wherein each icon of at least one icon of the plurality of icons is associated with a respective type of audio source and is indicative of the respective type of audio source. For instance, an icon may provide a pictogram of the respective type of audio source.

For instance, the pointing object pointing to the direction on the arriving sound may represent an arrow.

According to an exemplary embodiment of all aspects of the invention, a movement of the audio source of interest on the display is indicated.

For instance, an optional camera of the apparatus may be used for determining the movement of the audio source of interest, and/or for instance, the sound signals received at the optional three or more microphones may be used to determine the movement of the audio source of interest. As an example, if the user interface comprises a visual interface, the information on the movement may be displayed as visualized movement identifier, e.g., by means of displaying an optional trailing tail being indicative of the movement of the audio source of interest, wherein the visualized movement identifier may be visually attached to direction identifier thereby optionally indicating a former route that the audio source of interest has passed until now.

According to an exemplary embodiment of all aspects of the invention, said user interface comprises an audio interface, wherein said providing the direction identifier comprises acoustically providing the direction identifier via the audio interface.

For instance, the audio interface may be configured to provide sound to a user via at least one loudspeaker. As an example, the direction identifier provided by the audio interface may for instance represent a spoken information being descriptive of the direction of the audio source. For instance, said information being descriptive of the direction may comprise information whether the sound arrives from the front or rear of the user, e.g. the spoken wording “front” or “rear” or the like, and may comprise further information on the direction, e.g. “left”, “mid” or “right” or the like. For instance, this spoken information being descriptive of the direction may be stored as digitized samples for different directions and one of the spoken information may be selected and played back in accordance with the determined direction of the arriving sound from the audio source of interest. For instance, said BLOBs may represent said digitized samples.

Furthermore, as an example, said optional audio interface may be configured to provide a spatial audio signal to a user. For instance, said optional audio interface may represent a headset comprising two loudspeakers, which can be controlled by the apparatus in order play back spatial audio. Then, as an example, the direction identifier may comprise an audio signal provided in a spatial direction corresponding to the arriving sound from the audio source of interest via the audio interface.

As an example, if said spatial audio interface is configured to play back binaural sound, the audio signal of the direction identifier may be panned with the respective binaural direction, or, for instance, if said spatial audio interface represents a multichannel audio interface, the audio signal of the direction identifier may be panned at a correct position in the channel of the multichannel system corresponding to the direction of the arriving sound.

According to an exemplary embodiment of all aspects of the invention, the direction of an audio source of interest is determined based on audio signals captured from three or more microphones, wherein the three or more microphones are arranged in a predefined geometric constellation with respect to the apparatus.

For instance, an optional spatial sound detector may comprise the three or more microphone and may be configured to capture arriving sound from the environment. As an example, this spatial sound detector may further be configured to determine the direction of a dominant audio source of the environment with respect to the spatial sound detector, wherein the dominant audio source may represent the loudest audio source of the environment, or the spatial sound detector may be configured to provide a signal representation of the captured spatial sound to the processor, wherein the processor is configured to determine direction of a dominant audio source of the environment with respect to the spatial sound detector based on the signal representation.

Furthermore, it may be assumed that the spatial sound detector is arranged in a predefined position and orientation with respect to apparatus such that it is possible to determine the direction of the dominant audio source of the environment with respect to the apparatus based on the arriving sound captured from the spatial sound detector.

For instance, the apparatus may comprise the spatial sound detector or the spatial sound detector 16 may be fixed in a predefined position to the apparatus.

For instance, due the presence of the three or more microphone an angle of arrival of the arriving sound can be determined, wherein this angle of arrival may represent an two-dimensional or a three-dimensional angle.

According to an exemplary embodiment of all aspects of the invention, the distance from the apparatus to the audio source of interest is determined and information on the distance is provided via the user interface.

For instance, the distance may be determined by means of a camera with a focusing system, wherein the camera may be automatically directed to the audio source of interest, wherein the focusing system focuses the audio source of interest and can provide information on the distance between the camera and the audio source of interest. For instance, the camera may be integrated in the apparatus. It has to be understood that other well-suited approaches for determining the distance from the apparatus to the audio source of interest may be used.

The information on the distance may be provided to the user via the audio interface and/or via the visual interface.

For instance, if a display is used as user interface, the information on the distance may be provided as a kind of visual identifier of the distance, e.g. by displaying the distance in terms of meters, miles, centimeters, inches, or any other suited unit of length.

According to an exemplary embodiment of all aspects of the invention, said checking whether an audio signal captured from the environment of the apparatus comprises arriving sound from an audio source of interest comprises: checking whether a sound of the captured audio signal exceeds a predefined level, and if said checking yields a positive result, and proceeding with said providing the direction identifier being indicative on the direction of the arriving sound from the audio source of interest via a user interface.

For instance, said predefined level may represent a predefined loudness or a predefined energy level of the audio signal. Furthermore, the predefined level may depend on the frequency of the captured signal.

As an example, if the checking whether a sound of the captured audio signal exceeds a predefined level yields a positive result, it may be detected that the captured audio signal comprises sound from an audio source of interest, and the method may proceed with determining the direction of the sound.

For instance, the checking performed in step may represent a first rule for checking whether an audio signal captured from an environment of the apparatus comprises arriving sound from an audio source of interest performed in step.

For instance, the predefined level may be a constant predefined level or may be variable. As an example, different predefined levels may be used for different frequency ranges of the captured audio signal.

According to an exemplary embodiment of all aspects of the invention, a warning message is provided via the user interface if the sound of the captured audio signal exceeds a predefined level.

For instance, said warning message may represent a message being separate to the provided direction identifier, or as an example, the direction identifier may be provided in an attention seeking way. For instance, said attention seeking way may comprise, if the user interface normally presents a stream to the user, e.g. an audio stream in case of an audio interface and/or a video stream in case of a display as visual interface, providing the direction by overlaying the direction identifier at most largely or completely on the stream outputted by the user interface. For instance, said overlying the direction identifier completely on the stream may comprise stopping playback of the stream. Thus, the attention can be directly drawn to the direction identifier.

For instance, the predefined level used for providing a warning message may represent level being higher than the predefined level used for checking whether an audio signal captured from the environment of the apparatus comprises arriving sound from an audio source of interest. Thus, as an example, only for audio sources providing a very loud sound to the apparatus a warning message is provide via the user interface, as it may be assumed that very loud audio sources may represent potentially dangerous object, e.g. like near cars, emergency vehicles, car horns, loud machinery such as coming snowplow and trash collector, or the like.

According to an exemplary embodiment of all aspects of the invention, it is checked whether a sound of the captured audio signal matches with a sound profile stored in a database comprising a plurality of sound profiles, wherein each sound profile of the plurality of sound profiles is associated with a respective type of audio source of interest.

Thus, in said database the sound profiles of any types of audio sources of interest may be stored and based on the checking whether a sound of the captured audio signal matches with a sound profile stored in a database comprising a plurality of sound profiles, it can be determined whether the sound of the captured sound signal matches with one of the sound profiles stored in the database.

For instance, said stored sound profiles may comprise a sound profiles for cars, barking dogs and other objects that emits sound in the environment and may be of interest for a user.

Said matching may represent any well-suited kind of determining whether there is a sufficient similarity between the sound of the captured sound profile and a sound profile of one of the sound profiles of the database.

If there is a sufficient similarity between the sound of the captured audio signal and one sound profile of the database, then, for instance, it may be determined that the audio source associated with this sound profile of the database is detected. Thus, as an example, identification of the detected audio source may be possible based on database comprising a plurality of sound profiles.

According to an exemplary embodiment of all aspects of the invention, said checking whether an audio signal captured from the environment of the apparatus comprises arriving sound from an audio source of interest comprises said checking whether a sound of the captured audio signal matches with a sound profile stored in a database comprising a plurality of sound profiles.

Accordingly, the checking whether a sound of the captured audio signal matches with a sound profile stored in a database comprising a plurality of sound profiles may be used for determining whether an audio signal captured from the environment of the apparatus comprises arriving sound from an audio source of interest. As an example, only if the audio signal comprises sound which matches with a sound profile stored in the database, it may determined that an audio source of interest is detected. For instance, the database may comprise a first plurality of sound profiles being associated with audio sources of interest and a second plurality of sound profiles being associated with audio source of non-interest. Thus, only if the match can be found with respect to the first plurality of sound profiles stored in the database, it may determined that an audio source of interest is detected.

As an example, the checking whether a sound of the captured audio signal matches with a sound profile stored in a database comprising a plurality of sound profiles may be considered as a second rule for checking whether an audio signal captured from the environment of the apparatus comprises arriving sound from an audio source of interest.

For instance, the checking whether an audio signal captured from the environment of the apparatus comprises arriving sound from an audio source of interest may be performed with one rule of checking or two or more rules of checking, wherein checking of may only yield a positive result when each of the two or more rules of checking yields a positive result.

According to an exemplary embodiment of all aspects of the invention, information on the type of identified audio source is provided via the user interface.

For instance, if there are several sound profiles in the database having sufficient similarity with the sound of the captured sound profile, the sound profile of the database is selected providing the best similarity with the sound of the captured audio signal.

For instance, the information on the type of the identified audio source may be provided by means of a visual identifier being descriptive of the type of the identified audio source being presented on a visual interface of the user interface.

Or, as an example, a binary large object, an icon, or a familiar picture being indicative of the identified audio source may be used a visual identifier for providing the information on the type of the identified audio source by means of an visual interface.

Furthermore, as an example, if the direction identifier is provided via a visual interface, the colour of the direction identifier may be chosen in dependency of the identified type of audio source. For instance, without any limitations, if the type of audio source represents a human audio source, e.g. a human voice, the colour of the direction identifier may represent a first colour, e.g. green, or, if the type of audio source represents a high frequency audio source, e.g. an insect or the like, the colour of the direction identifier may represent a second colour, e.g. blue, or, if the type of audio source represents a low frequency audio source, the colour of the direction identifier may be represent a third colour, e.g. red, and so on. It has to be understood that other assignments of the colours may be used.

For instance, the visual identifier may be combined with the direction identifier represented to the user via the user interface.

Thus, for instance, the direction identifier may comprise the visual identifier or may represent the visual identifier, wherein in the latter case the visual identifier may be placed at a position on the visual interface that corresponds to the direction of the arriving sound.

Or, as an example, the information on the type of the identified audio source may represent an acoustical identifier which can be provided via an audio interface of the user interface. For instance, said acoustical identifier may played back as a sound being indicate of the type of the identified audio, e.g., with respect to the second and third example scenario, the sound of barking dog may be played via an audio interface. Furthermore, the acoustical identifier may be combined with the direction identifier represented to the user via the audio interface. For instance, the acoustical identifier may be played backed as acoustical signal in a spatial direction of a spatial audio interface corresponding to the direction of the arriving sound from the audio source of interest via the spatial audio interface. As an example, if said spatial audio interface is configured to play back binaural sound, the acoustical identifier may be panned with the respective binaural direction, or if said spatial audio interface represents a multichannel audio interface, the acoustical identifier may be panned at a correct position in the channel corresponding to the direction of the arriving sound.

Furthermore, for instance, the different types of audio source and the associated sound profiles stored in the database may comprise different types of human audio sources, wherein each type of human audio source may be associated with a respective person. Thus, a respective person may be identified based on the audio signal captured from the environment if the sound of the audio signal matches with the sound profile associated with the respective person, i.e., associated with the sound profile associated with the respective type of audio source representing the respective person.

According to an exemplary embodiment of all aspects of the invention, a warning message is provided via the user interface if the type of identified audio source represents a potentially dangerous audio source.

For instance, a potentially dangerous audio source may represent a near car, emergency vehicle, car horns, loud machinery such as coming snowplow and trash collector, which may move even in normal foot walks, a warning message may be provided via the user interface.

As an example, said warning message may represent a message being separate to the provided direction identifier, or as an example, the direction identifier may be provided in an attention seeking way. For instance, said attention seeking way may comprise, if the user interface normally presents a stream to the user, e.g. an audio stream in case of an audio interface and/or a video stream in case of a display as visual interface, providing the direction by overlaying the direction identifier at most largely or completely on the stream outputted by the user interface. For instance, said overlying the direction identifier completely on the stream may comprise stopping playback of the stream. Thus, the attention can be directly drawn to the direction identifier.

According to an exemplary embodiment of all aspects of the invention, said arriving sound from an audio source of interest was captured previously, and time information being indicative of the time when the arriving sound from the audio source of interest was captured is provided.

As an example, the apparatus be may operated in a security or surveillance mode, wherein in this mode the apparatus performs checking whether an audio signal captured from the environment of the apparatus comprises arriving sound from an audio source of interest as mentioned above with respect to any aspect to the invention.

If this checking yields a positive result, the method may not immediately proceed with for providing a direction identifier being indicative on the direction of the arriving sound from the audio source of interest via a user interface, but may proceed with storing time information on the time when the audio signal is captured, e.g. a time stamp, and may store at least the information on the direction of the arriving sound from the audio source of interest. Furthermore, for instance, any of the above mentioned type of additional information, e.g. the type of identified audio source of interest, and/or the distance between the apparatus and the audio source of interest and any other additional information associated with the audio source of interest may be stored and may be associated with the time information and the information on direction of the arriving sound.

Accordingly, audio events of interest can be detected during the security or surveillance mode, and at least the information on the direction of the arriving sound from the respective detected audio source of interest and the respective time information is stored.

Afterwards, for instance when the security or surveillance mode is left, it may be proceeded with providing a direction identifier being indicative on the direction of the arriving sound from the at least one detected audio source based on the information on the direction of the arriving sound from the audio source of interest stored previously. This providing the direction identifier may be performed in any way as mentioned above with respect to providing the direction identifier of any aspects of the invention. If more than one audio source of interest was captured during the security mode, the respective direction identifiers of the different detected audio sources of interest may for instance be provided sequentially via the user interface or at least two of the direction identifiers may be provided in parallel via the user interface.

Furthermore, time information being indicative of the time when the arriving sound from the audio source of interest was captured is provided in based on the time information stored previously. Thus, for instance, for each of at least one detected audio source of interest the respective time information can be provided. As an example, the time information of an audio source of interest may be provided in conjunction with the respective direction identifier, and, for instance, in conjunction with any additional information stored.

For instance, the time information may represent the time corresponding to the time stamp stored previously, e.g. additionally combined with the date, or this time information may indicate the time that has passed since the audio source of interest was captured.

Accordingly, it is possible, to see which audio sources of interest were captured during the security mode, wherein the direction identifier and the time information of the respective detected audio source of interest is provided to the user via the user interface.

Accordingly, for instance, past audio events of interest may be shown on the screen together with respective time information associated with the respective audio event of interest.

According to an exemplary embodiment of all aspects of the invention, said apparatus represents a handheld device.

For instance, the handheld device may represent a smartphone, pocket computer, tablet computer or the like.

Other features of all aspects of the invention will be apparent from and elucidated with reference to the detailed description of embodiments of the invention presented hereinafter in conjunction with the accompanying drawings. It is to be understood, however, that the drawings are designed solely for purposes of illustration and not as a definition of the limits of the invention, for which reference should be made to the appended claims. It should further be understood that the drawings are not drawn to scale and that they are merely intended to conceptually illustrate the structures and procedures described therein. In particular, presence of features in the drawings should not be considered to render these features mandatory for the invention.

### BRIEF DESCRIPTION OF THE FIGURES

In the figures show:

FIG. 1a: A schematic illustration of an apparatus according to an embodiment of the invention;

FIG. 1b: a tangible storage medium according to an embodiment of the invention;

FIG. 2a: a flowchart of a method according to a first embodiment of the invention;

FIG. 2b: a first example scenario of locating an audio source of interest;

FIG. 3a: a second example scenario of locating an audio source of interest;

FIG. 3b: an example of providing an directional identifier with respect to the second example scenario of locating an audio source of interest according to an embodiment of the invention;

FIG. 3c: a third example scenario of locating an audio source of interest;

FIG. 3d: an example of providing an directional identifier with respect to the third example scenario of locating an audio source of interest according to an embodiment of the invention;

FIG. 4: a flowchart of a method according to a second embodiment of the invention;

FIG. 5a: a flowchart of a method according to a third embodiment of the invention;

FIG. 5b: a flowchart of a method according to a fourth embodiment of the invention;

FIG. 6: a flowchart of a method according to a fifth embodiment of the invention;

FIG. 7a: a fourth example scenario of locating an audio source of interest;

FIG. 7b: an example of providing a warning message according to an embodiment of the invention;

FIG. 8: an example of providing a distance information according to an embodiment of the invention;

FIG. 9a: a flowchart of a method according to a sixth embodiment of the invention; and

FIG. 9b: an example of providing a time information according to the sixth embodiment of the invention.

### DETAILED DESCRIPTION OF EMBODIMENTS OF THE INVENTION

Example embodiments of the present invention disclose how to provide a direction identifier being indicative on the direction of the arriving sound from the audio source of interest via a user interface. For instance, this can be done when an apparatus is positioned in an environment, e.g. an indoor or an outdoor environment, wherein the apparatus may be at a fixed position or may move through the environment. As an example, the apparatus may represent a mobile device like a handheld device or the like.

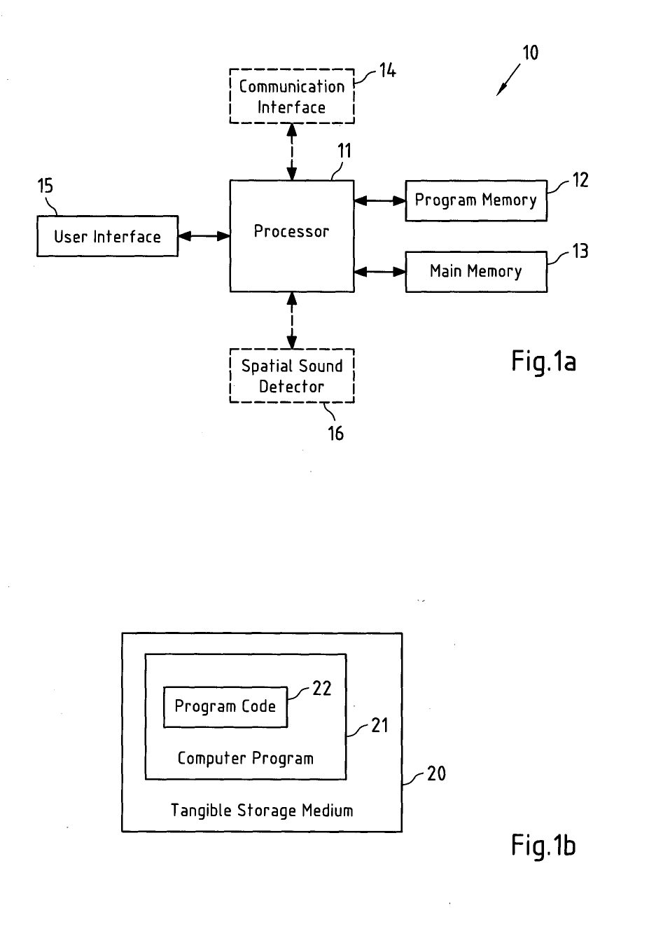

FIG. 1a is a schematic block diagram of an example embodiment of an apparatus 10 according to the invention. Apparatus 10 may or may form a part of a consumer terminal.

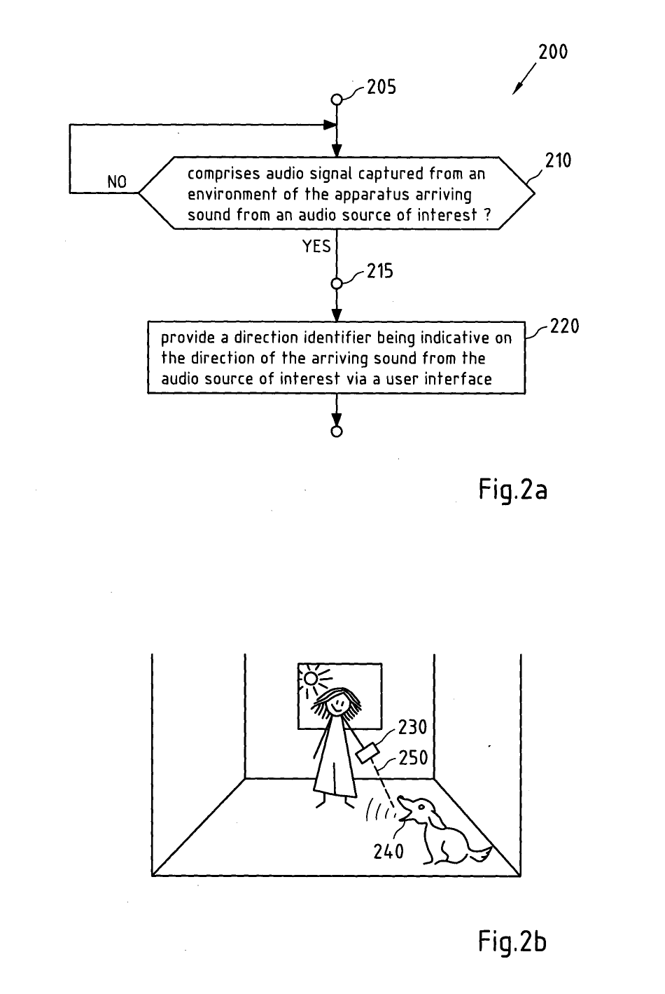

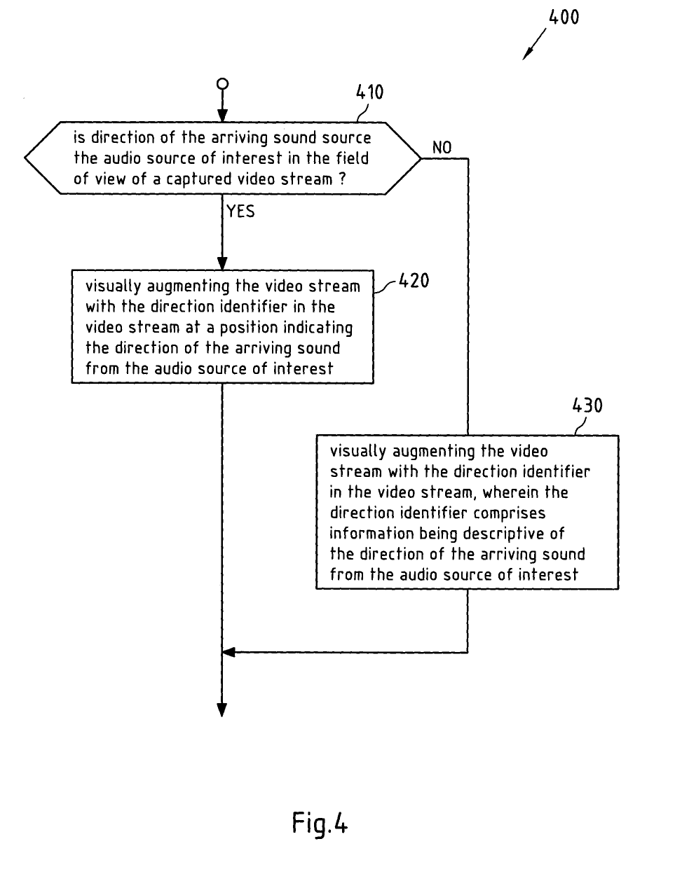

Apparatus 10 comprises a processor 11, which may for instance be embodied as a microprocessor, Digital Signal Processor (DSP) or Application Specific Integrated Circuit (ASIC), to name but a few non-limiting examples. Processor 11 executes a program code stored in program memory 12 (for instance program code implementing one or more of the embodiments of a method according to the invention described below with reference to FIGS. 2a, 4. 5a. 5b, 6, 9), and interfaces with a main memory 13, which may for instance store the plurality of set of positioning reference data (or at least a part thereof). Some or all of memories 12 and 13 may also be included into processor 11. Memories 12 and/or 13 may for instance be embodied as Read-Only Memory (ROM), Random Access Memory (RAM), to name but a few non-limiting examples. One of or both of memories 12 and 13 may be fixedly connected to processor 11 or removable from processor 11, for instance in the form of a memory card or stick.

Processor 11 may further control an optional communication interface 14 configured to receive and/or output information. This communication may for instance be based on a wire-bound or wireless connection. Optional communication interface 14 may thus for instance comprise circuitry such as modulators, filters, mixers, switches and/or one or more antennas to allow transmission and/or reception of signals. For instance, optional communication interface 14 may be configured to allow communication according to a 2G/3G/4G cellular CS and/or a WLAN.

Processor 11 further controls a user interface 15 configured to present information to a user of apparatus 10 and/or to receive information from such a user. Such information may for instance comprise a direction identifier being indicative on the direction of the arriving sound from the audio source of interest. As an example, said user interface may comprise at least one of a visual interface and an audio interface.

For instance, processor 11 may further control an optional spatial sound detector 16 which is configured to capture arriving sound from the environment. As an example, this spatial sound detector 16 may further be configured to determine the direction of a dominant audio source of the environment with respect to the spatial sound detector 16, wherein the dominant audio source may represent the loudest audio source of the environment, or the spatial sound detector 16 may be configured to provide a signal representation of the captured spatial sound to the processor, wherein the processor is configured to determine direction of a dominant audio source of the environment with respect to the spatial sound detector 16 based on the signal representation. Furthermore, it is assumed that the spatial sound detector is arranged in a predefined position and orientation with respect to apparatus 10 such that it is possible to determine the direction of the dominant audio source of the environment with respect to the apparatus 10 based on the arriving sound captured from the spatial sound detector 16.

For instance, the apparatus 10 may comprise the spatial sound detector 16 or the spatial sound detector 16 may be fixed in a predefined position to the apparatus 10. Furthermore, as an example, the spatial sound detector may comprise three or more microphones in order to capture sound from the environment.

It is to be noted that the circuitry formed by the components of apparatus 10 may be implemented in hardware alone, partially in hardware and in software, or in software only, as further described at the end of this specification.

FIG. 1b is a schematic illustration of an embodiment of a tangible storage medium 20 according to the invention. This tangible storage medium 20, which may in particular be a non-transitory storage medium, comprises a program 21, which in turn comprises program code 22 (for instance a set of instructions). Realizations of tangible storage medium 20 may for instance be program memory 12 of FIG. 1. Consequently, program code 22 may for instance implement the flowcharts of FIGS. 2a, 4. 5a. 5b, 6, 9 discussed below.

FIG. 2a shows a flowchart 200 of a method according to a first embodiment of the invention. The steps of this flowchart 200 may for instance be defined by respective program code 22 of a computer program 21 that is stored on a tangible storage medium 20, as shown in FIG. 1b. Tangible storage medium 20 may for instance embody program memory 11 of FIG. 1a, and the computer program 21 may then be executed by processor 10 of FIG. 1. The method 200 will be explained in conjunction with the example scenario of locating an audio source of interested depicted in FIG. 2b.

Returning to FIG. 2a, in a step 210 it is checked whether an audio signal captured from an environment of an apparatus 230 comprises arriving sound 250 from an audio source of interest 240, and if this checking yields a positive result, it is proceeded in a step 220 with providing a direction identifier being indicative on the direction of the arriving sound 250 from the audio source 240 of interest via a user interface. For instance, this audio signal may represent an actually captured audio signal or a previously captured audio signal.

As exemplarily depicted in FIG. 2b, the apparatus 230 may represent a mobile apparatus. For instance, the apparatus 230 may represent a handheld device, e.g. a smartphone or tablet computer or the like. The apparatus 230 is configured to determine the direction of a dominant audio source with respect to the orientation of the apparatus 230. For instance, the apparatus 230 may comprise or be connected to the spatial sound detector 16, as explained with respect to FIG. 1a, in order to determine the direction of a dominant audio source with respect to the orientation of the apparatus 230.

In the sequel, it may be assumed without any limitation that the spatial sound detector is part of the apparatus 230.

As an example, the determined direction may be a two-dimensional direction or a three-dimensional direction. With respect to the exemplary scenario depicted in FIG. 2b, the barking dog 240 represents the dominant audio source of the environment, since the sound emitted from the dog is received as loudest arrival sound 250 at the apparatus 230.

Based on the captured sound it is checked in step 210 whether the sound comprise arriving sound 250 from an audio source of interest 240. For instance, the apparatus may comprise at least one predefined rule in order to determine whether a captured sound comprises arriving sound from an audio source of interest. As an example, a first rule may define that an arrived sound exceeding a predefined signal level represents a sound from an audio source of interest and/or a second rule may define that an arrived sound comprising a sound profile which substantially matches with a sound profile of database comprising a plurality of stored sound profiles of audio sources of interest represents a sound from an audio source of interest. With respect to the exemplary scenario depicted in FIG. 2b, it may be determined in step 210 that arriving sound 250 from the barking dog 240 represents an arriving sound from an audio source of interest, for instance, since the signal level of the captured sound exceeds a predefined level.

Thus, sound arrived from audio sources of interest may be distinguished from other audio source, i.e., audio sources not of interest, and thus, a direction identifier being indicative on the direction of the arriving sound 250 may be only presented via the user interface if the captured sound comprises arriving sound from an audio source of interest.

For instance, sound captured from an audio source which is located far away from the apparatus 230 may not represent a sound from an audio source of interest, since the audio source is far a way from the apparatus 230 and, for instance, may thus cause no danger for a user of the apparatus. As an example, in this scenario only a weak sound signal may be received, and when the exemplary first rule may be used for determining whether the captured sound comprises arriving sound from an audio source of interest, the level of the captured sound may not exceed the predefined signal level and thus no audio source if interest may be detected in step 210.

Accordingly, no direction identifier being indicative on the direction of the arriving sound is presented if the audio source was not determined to represent an audio source of interest in step 210. Thus, no unnecessary information is presented to the user via the user interface, and, due to the less information provided via the user interface, power consumption of the apparatus may be reduced.

The direction identifier being indicative on the direction of the arriving sound from the audio source of interest provided via the user interface may represent any information which indicates the direction of the arriving sound from the audio source of interest with respect to the orientation of the apparatus 230.

For instance, the user interface may comprise a visual interface, e.g. a display, and/or an audio interface, and the direction identifier may be provided via the visual interface and/or the audio interface to a user. Accordingly, the direction identifier may comprise a visual direction identifier and/or an audio direction identifier.

Thus, a user can be informed about the direction of the sound of interest by means of the direction identifier provided via the user interface.

For instance, if a user walks around an outdoor environment, thereby listening music with noise suppressing headset from the apparatus 230, and, as an example, a dog barks loudly behind the user, the user would usually not be able to identify this dog due to wearing the noise suppressing headset, but the apparatus 230 would determine that a captured sound from dog barking behind the user represents an arrived sound from an audio source of interest in step 210, and thus a corresponding direction identifier could be provided to the user via the user interface being indicative of the direction of the arriving sound from the audio source of interest, i.e., the barking dog. Accordingly, although the noise suppressing headset acoustically encapsulates the user from the environment, the user is informed about audio sources of interest, even if the audio source of interest is not in the field of view of the user. Thus, for instance, the user may be informed about dangerous objects if these dangerous objects can be identified as audio source of interest by means of presenting the direction identifier being indicative of the via the user interface.

Furthermore, for instance, after the direction indicator has been provided in step 220, the method may jump to the beginning (indicated by reference number 205) in FIG. 2a and may proceed with determining whether an audio signal captured from an environment of the apparatus comprises arriving sound from an audio source of interest.

For instance, if the user interface comprises an audio interface, e.g. an audio interface being configured to provide sound to a user via at least one loudspeaker. Then, as an example, the direction identifier provided by the audio interface may for instance represent a spoken information being descriptive of the direction of the audio source. For instance, said information being descriptive of the direction may comprise information whether the sound arrives from the front or rear of the user, e.g. the spoken wording “front” or “rear” or the like, and may comprise further information on the direction, e.g. “left”, “mid” or “right” or the like. For instance, this spoken information being descriptive of the direction may be stored as digitized samples for different directions and one of the spoken information may be selected and played back in accordance with the determined direction of the arriving sound from the audio source of interest.

Furthermore, as an example, said optional audio interface may be configured to provide a spatial audio signal to a user. For instance, said optional audio interface may represent a headset comprising two loudspeakers, which can be controlled by the apparatus in order play back spatial audio. Then, as an example, the direction identifier may comprise an audio signal provided in a spatial direction corresponding to the arriving sound from the audio source of interest via the audio interface.

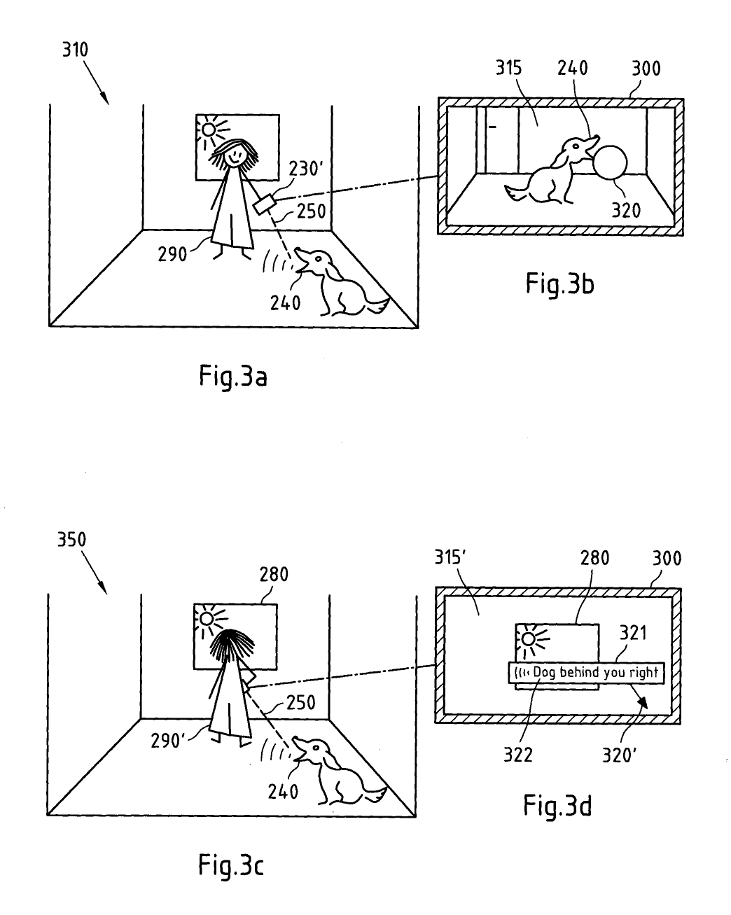

FIG. 3a depicts a second example scenario of locating an audio source of interest.

This second example scenario of locating an audio source of interest basically corresponds to the first example scenario depicted in FIG. 2b. The apparatus 230′ of the second example scenario is based on the apparatus 230 mentioned above and comprises a visual interface 300. For instance, said visual interface 300 may represent a display 300 and may be configured to stream a video stream 315.

FIG. 3b depicts an example of providing an directional identifier with respect to the second example scenario of locating an audio source of interest according to an embodiment of the invention on the display 300 of apparatus 230′.

In this example, the video stream 315 may represent an actually captured video stream of the environment, wherein the apparatus 300 is configured to capture images by means of camera.

With respect to the second example scenario depicted in FIG. 3a, the user 290 holds the apparatus 300 in a direction that that the camera of the apparatus 300 captures images in line of sight of the user. Thus, in this example depicted in FIG. 3a, the direction of the field of view of the captured video stream 315 displayed in the display 300 basically corresponds to the direction of the field of view of the user 290. Accordingly, the dog 240 is displayed on the video stream.

As mentioned above with respect to method 200, in step 210 it may be determined that the sound from the barking dog 240 represents sound from an audio source of interest. Then, in step 220 a direction identifier 320 being indicative on the direction of the arriving sound from the audio source of interest 240 is provided to the user via the user interface 300, i.e., the display 300 in accordance with the second example scenario depicted in FIG. 3a.

For instance, as exemplarily depicted in FIG. 3b, the video stream shown 315 on the display 300 may be visually augmented with the direction identifier 320. As an example, this may comprise visually augmenting the video stream with the direction identifier in the video stream 315 at a position indicating the direction of the arriving sound from the audio source of interest, i.e., with respect to the example depicted in FIG. 3b, at the position of the dog's 240 mouth. Thus, the position of the direction identifier 320 indicates the direction of the arriving sound from the audio source of interest in this example.

Accordingly, due to the presence of the direction identifier 320 visually augmented on the video stream 315 displayed on the display 300 the user 290 is informed about the audio source of interest, i.e., the barking dog 240.

FIG. 3c depicts a third example scenario of locating an audio source of interest.

This third example scenario of locating an audio source of interest basically corresponds to the second example scenario depicted in FIG. 2b, but the user 290′ is oriented to the window 280 and holds the apparatus 230′ (not depicted in FIG. 3c) in direction of the window. Thus, the apparatus 230′ captures images in another field of the view compared to the field of view depicted in FIGS. 3a and 3b, and the captured video stream 315′ displayed on display 300 has a different field of view, including the window 280, but not comprising the dog 240.

FIG. 3d depicts an example of providing an directional identifier 320′ with respect to the third example scenario of locating an audio source of interest according to an embodiment of the invention on the display 300 of apparatus 230′.

In this third example scenario the directional identifier 320′ comprises a pointing object pointing to the direction of the arriving sound 250 from the audio source of interest, i.e., the barking dog 240, wherein this pointing object may be realized as arrow 320′ pointing backwards/right.

Furthermore, as an example, the directional information 320′ may comprise information 321 on the type of the identified audio source. Providing information 321 on the type of the identified audio source will be explained in more detail with respect to methods depicted in FIGS. 2a, 4. 5a. 5b, 6, 9 and with respect to the embodiments depicted in the remaining Figs.

FIG. 4 depicts a flowchart of a method according to a second embodiment of the invention, which may for instance be applied to the second and third example scenario depicted in FIGS. 3a and 3c, respectively, i.e., when the user interface 300 comprises a display 300 showing a captured video stream of the environment according to a present field of view.

In step 410, it is checked whether the direction of the arriving sound from the audio source of interest is in the field of view of the captured video stream.

For instance, with respect to the second example scenario depicted in FIGS. 3a and 3b, the barking dog would be determined to represent an audio source of interest, wherein the direction of the arriving sound from the audio source of interest, i.e., the dog 240, is in the field of view of the captured video stream 315, since the audio source of interest 240 is in the field of view of the captured video stream.

Thus, with respect to the second example scenario, the checking performed in step 410 yields a positive result, and the method proceeds with step 420 for visually augmenting the video stream 315 with the direction identifier in the video stream at a position indicating the direction of the arriving sound from the audio source of interest. In the example depicted in FIG. 3b, a marker 320 being positioned at a position indicating the direction of the arriving sound from the audio source of interest 240 may be used as direction identifier. Thus, the directional identifier used in step 420 represents a directional identifier being placed in the captured video stream at a position indicating the direction of the arriving sound. Due to this position, the user is informed about the direction of the arriving sound.

Furthermore, considering step 410 with respect to the third example scenario depicted in FIGS. 3c and 3d, the direction of the arriving sound from the audio source of interest, i.e., the dog 240, is not in the field of view of the captured video stream 315, since the audio source of interest 240 behind the user 290′ and not in the field of view of the captured video stream.

Thus, with respect to the third example scenario, the checking performed in step 420 yields a negative result, and the method proceeds with step 430 for visually augmenting the video stream with the direction identifier in the video stream, wherein the direction identifier comprises information being descriptive of the direction of the arriving sound from the audio source of interest.

For instance, in step 430, a pointing object 320′ pointing to the direction of the arriving sound 250 from the audio source of interest may be used a direction identifier 320′, wherein this direction identifier is overlaid on the video stream 315. As an example, this pointing object 320′ may be shown in a border of the display 300 corresponding to the direction of the arriving sound and may be oriented in order to describe the direction of the arriving sound from the audio source of interest 240. In the third example embodiment, the barking dog 240 is positioned in back and in the right hand side of the apparatus 230′ on the floor, i.e. lower than apparatus 230′, and thus, the pointing object 230′ may be positioned in the lower right order of the display 300 pointing to the direction of the arriving sound, and the pointing objects 230′ points to the direction of the arriving sound, i.e., backwards/right. It has to be understood that other graphical representations may be used as directional identifier being descriptive of the arriving sound from the audio source of interest than the described pointing object 230′.

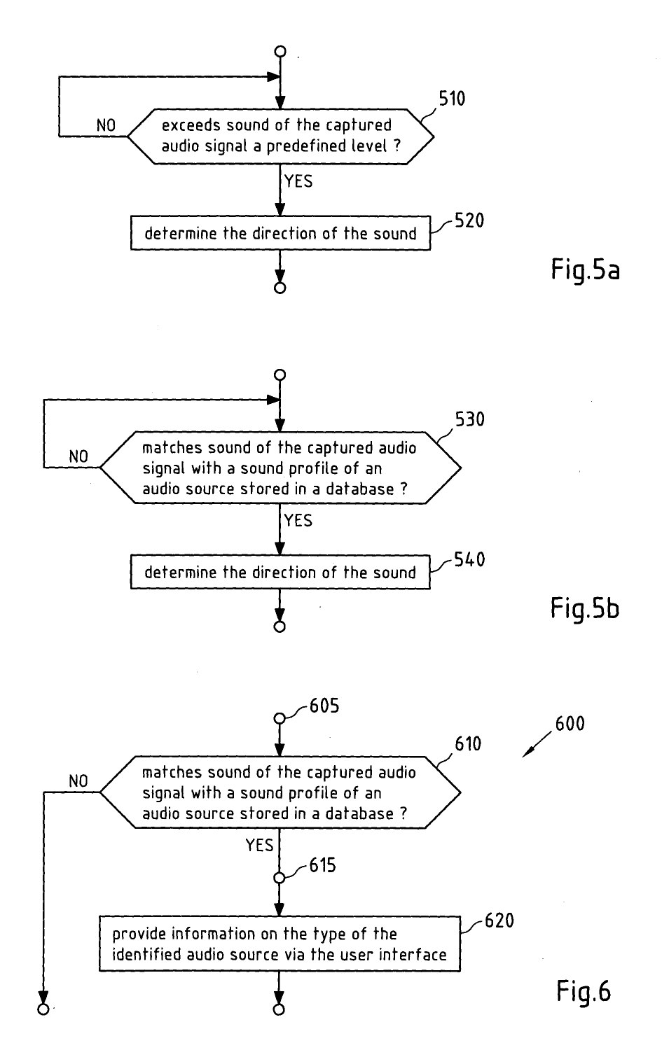

FIG. 5a depicts a flowchart of a method according to a third embodiment of the invention.

For instance, this method according to a third embodiment of the invention may at least partially be used for checking whether an audio signal captured from the environment of the apparatus comprises arriving sound from an audio source of interest performed in step 210 of the method depicted in FIG. 2a.

In step 510, it is checked whether the sound of the captured audio signal exceeds a predefined level. For instance, said predefined level may represent a predefined loudness or a predefined energy level of the audio signal. Furthermore, the predefined level may depend on the frequency of the captured signal.

If the checking performed in step 510 yields a positive result, it is detected that the captured audio signal comprises sound from an audio source of interest, and the method may proceed with determining the direction of the sound in step 520. Otherwise, i.e., if the checking yields a negative results, the method depicted in FIG. 5a may for instance jump to the beginning until it is detected that a sound of the captured audio signal exceed the predefined level in step 510.

Thus, for instance, step 210 of the method depicted in FIG. 2a may comprise at least step 510 of the method depicted in FIG. 5a.

For instance, the checking performed in step 510 may represent a first rule for checking whether an audio signal captured from an environment of the apparatus comprises arriving sound from an audio source of interest performed in step 210. Thus, for instance, step 210 may perform one rule of checking or two or more rules of checking, wherein checking of step 210 may only yield a positive result when each of the two or more rules of checking yield a positive result.

FIG. 5b depicts a flowchart of a method according to a fourth embodiment of the invention.

For instance, this method according to a fourth embodiment of the invention may at least partially be used for checking whether an audio signal captured from the environment of the apparatus comprises arriving sound from an audio source of interest performed in step 210 of the method depicted in FIG. 2a.

In step 530, it is checked whether sound of the captured audio signal matches with a sound profile of an audio source stored in a database comprising a plurality of sound profiles, wherein each sound profile of the plurality of sound profiles is associated with a respective type of audio source of interest.

Thus, in said database the sound profiles of any types of audio sources of interest may be stored and based on the checking performed in step 530, it can be determined whether the sound of the captured sound signal matches with one of the sound profiles stored in the database.

For instance, said stored sound profiles may comprise a sound profiles for cars, barking dogs and other objects that emits sound in the environment and may be of interest for a user.

Said matching may represent any well-suited kind of determining whether there is a sufficient similarity between the sound of the captured sound profile and a sound profile of one of the sound profiles of the database.

If there is a sufficient similarity between the sound of the captured audio signal and one sound profile of the database, then it may be determined that the audio source associated with this sound profile of the database is detected and thus the audio signal captured from the environment of the apparatus comprises arriving sound from this type of audio source and the method depicted in FIG. 5b may for instance proceed with determining the direction of the sound in step 540.

For instance, the checking performed in step 510 may represent a second rule for checking whether an audio signal captured from an environment of the apparatus comprises arriving sound from an audio source of interest performed in step 210. Thus, for instance, step 210 may perform one rule of checking or two or more rules of checking, wherein checking of step 210 may only yield a positive result when each of the two or more rules of checking yield a positive result.

For instance, the first rule, i.e., step 510, and the second rule, i.e., step 530, may be combined on order to check whether an audio signal captured from the environment of the apparatus comprises arriving sound from an audio source of interest.

Thus, only when the first rule and the second rule are fulfilled, it may be determined in step 210 the audio signal captured from an environment of the apparatus comprises arriving sound from an audio source of interest.

As an example, this combining may introduce a dependency of the predefined level in step 510 and the type of the identified audio source. For instance, if it is determined in step 530 that the sound of the captured audio signal matched with a sound profile of an audio source of interest stored in the database, the predefined level for determining whether the sound of the captured audio signal exceeds this predefine level may depend on the identified audio source of interest. For instance, if said identified audio source represents a quite dangerous audio source, the predefined level may be chosen rather small, and if said identified audio source represents a rather harmless audio source, the predefined level may be chosen rather high.

FIG. 6 depicts a flowchart of a method according to a fifth embodiment of the invention. For instance, this method according to a fifth embodiment of the invention may be combined with any of the methods mentioned above.

In step 610, it is checked whether sound of the captured audio signal matches with a sound profile of an audio source stored in a database comprising a plurality of sound profiles, wherein each sound profile of the plurality of sound profiles is associated with a respective type of audio source of interest. This checking performed in step 610 may be performed as explained with respect to the checking performed in step 530 depicted in FIG. 5b. Thus, the explanations presented with respect to step 530 also hold for step 610.

For instance, step 610 may be performed after it has been determined in step 210 of the method 200 depicted in FIG. 2a whether an audio signal captured from an environment of the apparatus comprises arriving sound from an audio source of interest, or, if step 530 is part of step 210, then step 610 may be omitted, and the method 600 may start at reference sign 615 if it was determined in step 530 that the sound of the captured audio signal matches with a sound profile of an audio source stored in the database.

Accordingly, in accordance with method 600, the method proceeds at reference 615 if the checking whether the sound of the captured audio signal matches with a sound profile of an audio source stored in the database, and then, in step 620, it is provided information on the type of the identified audio source via the user interface.

As explained with respect to the method depicted in FIG. 5b, if there is a sufficient similarity between the sound of the captured audio signal and one sound profile of the database, then it may be determined that the audio source associated with this sound profile of the database is detected, i.e., the respective audio source is identified based on the database. For instance, if there are several sound profiles in the database having sufficient similarity with the sound of the captured sound profile, the sound profile of the database is selected providing the best similarity with the sound of the captured audio signal.

Accordingly, the type of audio source can be identified if the checking in step 610 (or, alternatively, in step 530) yields a positive result.

Thus, in step 620 information on the type of the identified audio source is provided via the user interface.

For instance, the information on the type of the identified audio source may be provided by means of a visual identifier being descriptive of the type of the identified audio source being presented on a visual interface of the user interface. For instance, with respect to the third example scenario depicted in FIGS. 3c and 3d, the optional information on the type of the identified audio source may be provided by means of the visual identifier 322 being descriptive of the type of the identified audio source, i.e., the audio source “dog”.

Or, as an example, a binary large object, an icon, or a familiar picture being indicative of the identified audio source may be used a visual identifier for providing the information on the type of the identified audio source by means of an visual interface.

Furthermore, as an example, if the direction identifier is provided via a visual interface, the colour of the direction identifier may be chosen in dependency of the identified type of audio source. For instance, without any limitations, if the type of audio source represents a human audio source, e.g. a human voice, the colour of the direction identifier may represent a first colour, e.g. green, or, if the type of audio source represents a high frequency audio source, e.g. an insect or the like, the colour of the direction identifier may represent a second colour, e.g. blue, or, if the type of audio source represents a low frequency audio source, the colour of the direction identifier may be represent a third colour, e.g. red, and so on.

For instance, the visual identifier may be combined with the direction identifier represented to the user via the user interface. For instance, with respect to the second example scenario depicted in FIGS. 2a and 2b, the direction identifier 320 may represent an icon, wherein the icon may show a visualisation of the type of identified audio source, i.e., a dog according to the second example scenario.

Thus, for instance, the direction identifier may comprise the visual identifier or may represent the visual identifier, wherein in the latter case the visual identifier may be placed at a position on the visual interface that corresponds to the direction of the arriving sound.

Or, as an example, the information on the type of the identified audio source may represent an acoustical identifier which can be provided via an audio interface of the user interface. For instance, said acoustical identifier may played back as a sound being indicate of the type of the identified audio, e.g., with respect to the second and third example scenario, the sound of barking dog may be played via an audio interface. Furthermore, the acoustical identifier may be combined with the direction identifier represented to the user via the audio interface. For instance, the acoustical identifier may be played backed as acoustical signal in a spatial direction of a spatial audio interface corresponding to the direction of the arriving sound from the audio source of interest via the spatial audio interface. As an example, if said spatial audio interface is configured to play back binaural sound, the acoustical identifier may be panned with the respective binaural direction, or if said spatial audio interface represents a multichannel audio interface, the acoustical identifier may be panned at a correct position in the channel corresponding to the direction of the arriving sound.

Furthermore, for instance, the different types of audio source and the associated sound profiles stored in the database may comprise different types of human audio sources, wherein each type of human audio source may be associated with a respective person. Thus, a respective person may be identified based on the audio signal captured from the environment if the sound of the audio signal matches with the sound profile associated with the respective person, i.e., associated with the sound profile associated with the respective type of audio source representing the respective person.

Furthermore, as an example, if an audio source identified in step 610 (or, alternatively, in step 530) represents an audio source being associated with a potentially dangerous audio source, e.g., a near car, emergency vehicle, car horns, loud machinery such as coming snowplow and trash collector, which may move even in normal foot walks, a warning message may be provided via the user interface. For instance, said warning message may represent a message being separate to the provided direction identifier, or as an example, the direction identifier may be provided in an attention seeking way. For instance, said attention seeking way may comprise, if the user interface normally presents a stream to the user, e.g. an audio stream in case of an audio interface and/or a video stream in case of a display as visual interface, providing the direction by overlaying the direction identifier at most largely or completely on the stream outputted by the user interface. For instance, said overlying the direction identifier completely on the stream may comprise stopping playback of the stream. Thus, the attention can be directly drawn to the direction identifier.

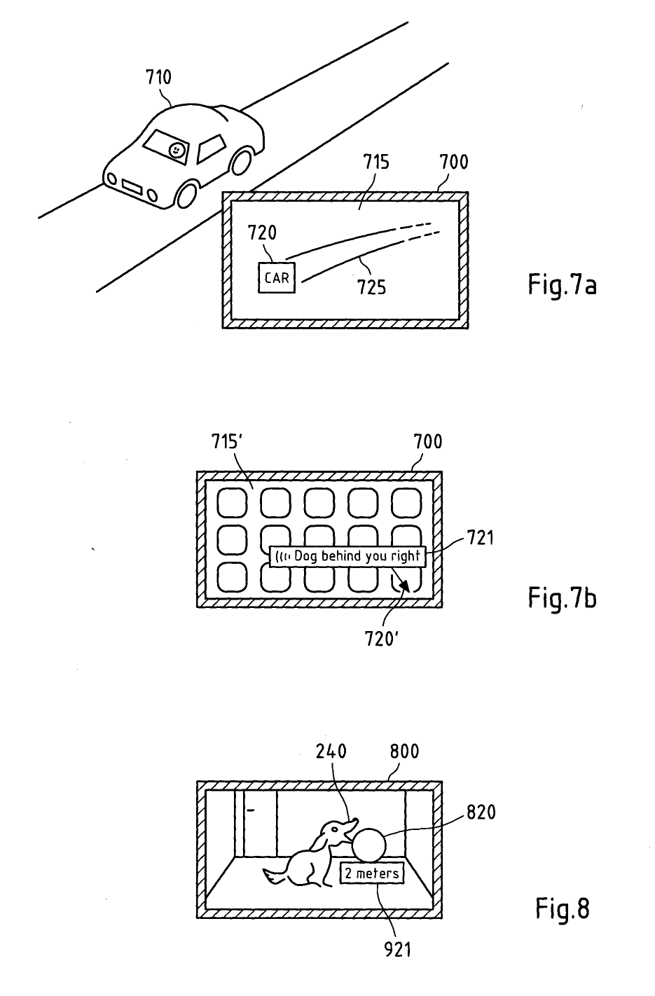

As an example, FIG. 7 represents a fourth example scenario of locating an audio source of interest, where a car 710 drives along a street in the environment.

In this fourth example scenario, it may be assumed without any limitation that the user interface comprises a display 700 which is configured to represent video stream 715, e.g. as explained with respect to the display 300 depicted in FIG. 3b.

For instance, the car 710 may be identified to represent an audio source representing a potentially dangerous audio source. Then, as an example, the warning message may provided by means of providing the direction identifier 720 in an attention seeking way, wherein the direction identifier 720 may overlay video stream 715 completely and may but visually put on the top of the display. Thus, the original video stream can not be seen anymore and the attention is drawn to the direction identifier 720 serving as a kind of warning message.

Furthermore, as an example, which may hold for any of the described methods, if the audio source of interest 710 represent an object moving in the environment, the movement of the audio source of interest 720 may be determined. For instance, a camera of the apparatus may be used for determining the movement of the audio source of interest 710, and/or for instance, the sound signals received at the three or more microphones may be used to determine the movement of the audio source of interest 710. When a movement of the audio source of interest 710 is determined, then, for instance, information on this movement may be provided to a user via the user interface. For instance, if the user interface comprises a visual interface, the information on the movement may be displayed as a visualisation of the movement, e.g., as exemplarily depicted in FIG. 7, by an optional trailing tail 725 being indicative of the movement of the audio source of interest 710.

Returning back to the providing a warning message if the identified audio source of interest represents an audio source being associated with a potentially dangerous audio source, another example of providing the warning message 721 is depicted in FIG. 7b, wherein the warning message 721, i.e., “Dog behind you right” is combined with the directional identifier 720′ and partially overlaps the video stream 715′ shown the display 700.

FIG. 8a depicts an example of providing a distance information according to an embodiment of the invention.

For instance, according to a method according to an exemplary embodiment of the invention, the method may comprise determining the distance from the apparatus to the audio source of interest and providing information on the distance 821 via the user interface.

For instance, the distance may be determined by means of a camera with a focusing system, wherein the camera may be automatically directed to the audio source of interest, i.e., the barking dog 240 in the example depicted in FIG. 8a, wherein the focusing system focuses the audio source of interest and can provide information on the distance between the camera and the audio source of interest. For instance, the camera may be integrated in the apparatus. It has to be understood that other well-suited approaches for determining the distance from the apparatus to the audio source of interest may be used.

The information on the distance may be provided to the user via the audio interface and/or via the visual interface.

For instance, as exemplarily depicted in FIG. 8a, if a display is used as user interface, the information on the distance may be provided as a kind of visual identifier of the distance 821, e.g. by displaying the distance in terms of meters, miles, centimeters, inches, or any other suited unit of length.

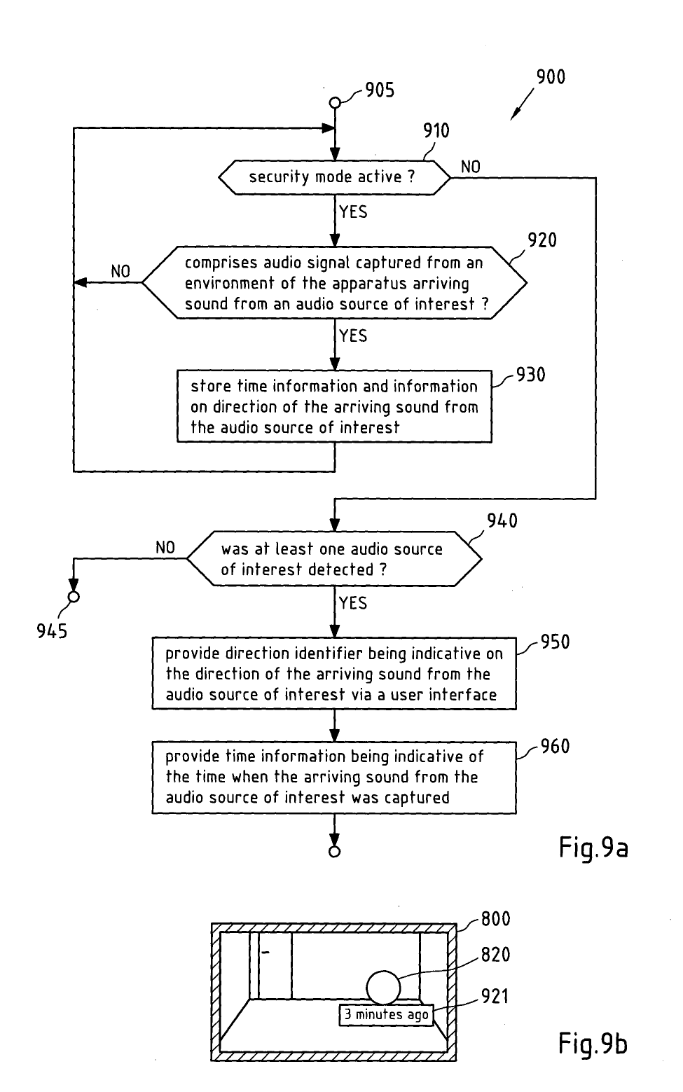

FIG. 9a depicts a flowchart of a method 900 according to a sixth embodiment of the invention. This method 900 will be explained in conjunction with FIG. 9b representing an example of providing a time information according to the sixth embodiment of the invention.

For instance, according to this method 900 according to an sixth embodiment of the invention, said arriving sound from an audio source of interest was captured previously, and the method comprises providing time information being indicative of the time of the arriving sound from the audio source of interest was captured (e.g. at step 960).

As an example, the apparatus be may operated in a security or surveillance mode, wherein in this mode the apparatus performs in step 920 checking whether an audio signal captured from the environment of the apparatus comprises arriving sound from an audio source of interest in the same way as step 210 of the method disclosed in FIG. 2a. Thus, the explanations provided with respect to 210 may also hold with respect to step 910 of method 900. For instance, step 910 may represent step 210 of the method depicted in FIG. 2a.

If this checking yields a positive result, the method does not immediately proceeds with step 220 for providing a direction identifier being indicative on the direction of the arriving sound from the audio source of interest via a user interface, but proceeds with storing time information on the time when the audio signal is captured, e.g. a time stamp, and stores at least the information on the direction of the arriving sound from the audio source of interest in step 930. Furthermore, for instance, any of the above mentioned type of additional information, e.g. the type of identified audio source of interest, and/or the distance between the apparatus and the audio source of interest and any other additional information may be stored in 930 and may be associated with the time information and the information on direction of the arriving sound.

Then, it may be checked in step 910 whether the security (or surveillance) mode is still active, and if this checking yields a positive result, the method may proceed with step 920. If this checking yields a negative result, the method proceeds with step 940 and checks whether at least one audio source was detected, e.g., if at least one time information and the respective information on direction was stored in step 930.

If this checking performed in step 940 yields a positive result, the method may proceed with providing a direction identifier being indicative on the direction of the arriving sound from the at least one detected audio source based on the information on the direction of the arriving sound from the audio source of interest stored in step 930. This providing the direction identifier may be performed in any way as mentioned above with respect to providing the direction identifier based on step 220 depicted in FIG. 2a. If more than one audio source of interest was captured during the security mode, the respective direction identifiers of the different detected audio sources of interest may for instance be provided sequentially via the user interface or at least two of the direction identifiers may be provided in parallel via the user interface.

Furthermore, time information being indicative of the time when the arriving sound from the audio source of interest was captured is provided in step 960 based on the time information stored in step 930. Thus, for instance, for each of at least one detected audio source of interest the respective time information can be provided in step 960. As an example, the time information of an audio source of interest may be provided in conjunction with the respective direction identifier, i.e., steps 950 and 960 may be performed merged together.

Accordingly, it is possible, to see which audio sources of interest were captured during the security mode, wherein the direction identifier and the time information of the respective detected audio source of interest is provided to the user via the user interface.

With respect to the example depicted in FIG. 9b, it is assumed that the barking dog 240 was captured during the security or surveillance mode, the respective directional identifier 820 being indicative on the direction of the arriving sound from the audio source of interest is provided on the display 800, and, additionally, time information 921 being indicate of the time when the arriving sound from the audio source of interest was captured is provided on the display. For instance, this time information may represent the time corresponding to the time stamp stored in step 930, e.g. additionally combined with the date, or this time information 921 may indicate the time that has passed since the audio source of interest was captured, e.g. 3 minutes in the example depicted in FIG. 9b.

Accordingly, for instance, past audio events of interest may be shown on the screen together with respective time information associated with the respective audio event of interest.

Alternatively, the time information may be provided via the audio interface.

As used in this application, the term ‘circuitry’ refers to all of the following:

(a) hardware-only circuit implementations (such as implementations in only analog and/or digital circuitry) and
(b) combinations of circuits and software (and/or firmware), such as (as applicable):
(i) to a combination of processor(s) or
(ii) to portions of processor(s)/software (including digital signal processor(s)), software, and memory(ies) that work together to cause an apparatus, such as a mobile phone or a positioning device, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a positioning device.

With respect to the aspects of the invention and their embodiments described in this application, it is understood that a disclosure of any action or step shall be understood as a disclosure of a corresponding (functional) configuration of a corresponding apparatus (for instance a configuration of the computer program code and/or the processor and/or some other means of the corresponding apparatus), of a corresponding computer program code defined to cause such an action or step when executed and/or of a corresponding (functional) configuration of a system (or parts thereof).

The aspects of the invention and their embodiments presented in this application and also their single features shall also be understood to be disclosed in all possible combinations with each other. It should also be understood that the sequence of method steps in the flowcharts presented above is not mandatory, also alternative sequences may be possible.

The invention has been described above by non-limiting examples. In particular, it should be noted that there are alternative ways and variations which are obvious to a skilled person in the art and can be implemented without deviating from the scope and spirit of the appended claims.

1-48. (canceled)

49. A method performed by an apparatus, said method comprising:
checking whether an audio signal captured from an environment of the apparatus comprises arriving sound from an audio source of interest, and
providing a direction identifier being indicative on the direction of the arriving sound from the audio source of interest via a user interface when said check yields a positive result.

50. The method according to claim 49, wherein said providing the direction identifier comprises overlaying the direction identifier at least partially on a stream outputted by the user interface.

51. The method according to claim 50, wherein said user interface comprises a display and said stream represents a video stream, and wherein said overlaying an indicator of the direction comprises one out of:
visually augmenting the video stream shown on the display with the direction identifier, and
stopping presentation of the video stream on the display and providing the direction identifier on top of the display.

52. The method according to claim 51, wherein the video stream represents a video stream captured from the environment, the method comprising checking whether the direction of the arriving sound from the audio source of interest is in the field of view of the captured video stream, and, if this checking yields a positive result, visually augmenting the video stream with the direction identifier in the video stream at a position indicating the direction of the arriving sound from the audio source of interest, and, if this checking yields a negative result, visually augmenting the video stream with the direction identifier in the video stream, wherein the direction identifier comprises information being descriptive of the direction of the arriving sound from the audio source of interest.

53. The method according to claim 51, wherein said direction identifier comprises at least one of the following:
a marker;
a binary large object;
an icon;
a pointing object pointing to the direction of the arriving sound.

54. The method according to claim 51, indicating a movement of the audio source of interest on the display.

55. A computer program product comprising a least one computer readable non-transitory memory medium having program code stored thereon, the program code which when executed by an apparatus cause the apparatus at least to check whether an audio signal captured from an environment of the apparatus comprises arriving sound from an audio source of interest, and to provide a direction identifier being indicative on the direction of the arriving sound from the audio source of interest via a user interface when said check yields a positive result.

56. An apparatus, comprising at least one processor; and at least one memory including computer program code, said at least one memory and said computer program code configured to, with said at least one processor, cause said apparatus at least to check whether an audio signal captured from an environment of the apparatus comprises arriving sound from an audio source of interest, and to provide a direction identifier being indicative on the direction of the arriving sound from the audio source of interest via a user interface when said check yields a positive result.

57. The apparatus according to claim 56, wherein said at least one memory and said computer program code is further configured to, with said at least one processor, cause said apparatus further to overlay the direction identifier at least partially on a stream outputted by the user interface when providing the direction identifier.

58. The apparatus according to claim 57, wherein said user interface comprises a display and said stream represents a video stream, and wherein said at least one memory and said computer program code is further configured to, with said at least one processor, cause said apparatus, when overlaying an indicator of the direction, to perform one out of:
to visually augment the video stream shown on the display with the direction identifier, and
to visually put the direction identifier on top of the display.

59. The apparatus according to claim 58, wherein the video stream represents a video stream captured from the environment, said at least one memory and said computer program code is further configured to, with said at least one processor, cause said apparatus further to check whether the direction of the arriving sound from the audio source of interest is in the field of view of the captured video stream, and, if this checking yields a positive result, to visually augment the video stream with the direction identifier in the video stream at a position indicating the direction of the arriving sound from the audio source of interest, and, if this checking yields a negative result, to visually augment the video stream with the direction identifier in the video stream, wherein the direction identifier comprises information being descriptive of the direction of the arriving sound from the audio source of interest.

60. The apparatus according to claim 58, wherein said direction identifier comprises at least one of the following:
a marker;
a binary large object;
an icon;
a pointing object configured to point to the direction of the arriving sound.

61. The apparatus according to claim 56, wherein said at least one memory and said computer program code is further configured to, with said at least one processor, cause said apparatus further to indicate a movement of the audio source of interest on the display.

62. The apparatus according to claim 56, wherein said user interface comprises an audio interface, and wherein said at least one memory and said computer program code is further configured to, with said at least one processor, cause said apparatus further to acoustically provide the direction identifier via the audio interface when providing the direction identifier.

63. The apparatus according to claim 62, wherein said audio interface is configured to provide a spatial audio signal to a user, and wherein said at least one memory and said computer program code is further configured to, with said at least one processor, cause said apparatus further to output an acoustical signal in a spatial direction corresponding to the direction of the arriving sound from the audio source of interest via the audio interface when providing the direction identifier.

64. The apparatus according to claim 56, wherein said at least one memory and said computer program code is further configured to, with said at least one processor, cause said apparatus further to determine the direction of an audio source of interest based on audio signals captured from three or more microphones, wherein the three or more microphones are arranged in a predefined geometric constellation with respect to the apparatus.

65. The apparatus according to claim 56, wherein said at least one memory and said computer program code is further configured to, with said at least one processor, cause said apparatus further to determine the distance from the apparatus to the audio source of interest and to provide information on the distance via the user interface.

66. The apparatus according to claim 56, wherein said check whether an audio signal captured from the environment of the apparatus comprises arriving sound from an audio source of interest comprises:
check whether a sound of the captured audio signal exceeds a predefined level, and if said check yields a positive result, proceed with said providing the direction identifier being indicative on the direction of the arriving sound from the audio source of interest via a user interface.

67. The apparatus according to claim 66, wherein said at least one memory and said computer program code is further configured to, with said at least one processor, cause said apparatus further to provide a warning message via the user interface if the sound of the captured audio signal exceeds a predefined level.

68. The apparatus according to claim 56, wherein said at least one memory and said computer program code is further configured to, with said at least one processor, cause said apparatus further to check whether a sound of the captured audio signal matches with a sound profile stored in a database comprising a plurality of sound profiles, wherein each sound profile of the plurality of sound profiles is associated with a respective type of audio source of interest.
